(19) United States
(12) Patent Application Publication
(10) Pub. No.: US 2005/0199546 A1
(43) Pub. Date: Sep. 15, 2005

(54) Separator for removing liquid from fluid

(75) Inventors: Ali Rusta-Sallehy, Falls Church, VA (US); Jianming Ye, Woodbridge (CA); Brian Tysoe, Toronto (CA)

Correspondence Address: BERESKIN AND PARR, 40 KING STREET WEST, BOX 401, TORONTO, ON, M5H 3Y2, CA

(73) Assignee: Hydrogenics Corporation, Mississauga (CA)

(21) Appl. No.: 10/945,444

(22) Filed: Sep. 21, 2004

Related U.S. Application Data
(60) Provisional application No. 60/504,226, filed on Sep. 22, 2003.

(51) Int. Cl. B01D 17/038

(52) U.S. Cl. 210/512.1; 96/216; 55/459.1

(57) ABSTRACT

A liquid separator includes a housing, a separation chamber disposed within the housing and having a substantially cylindrical inner surface, wherein the inner surface of the separation chamber is aligned about a substantially vertical chamber axis, an inlet channel configured to communicate the fluid stream from a first inlet end to a second inlet end disposed within the housing and proximate an upper region of the separation chamber, and an outlet channel configured to communicate the fluid stream from a first outlet end positioned proximate the upper region of the separation chamber, to a second outlet end remote from the separation chamber. Proximate the second inlet end the inlet channel is aligned about an inlet axis. A deflector vane may also be provided which is substantially aligned about the chamber axis and intersecting the inlet axis. The inlet axis is preferably proximate to and substantially parallel with a tangent to the inner surface of the separation chamber.

The present application claims priority from U.S. provisional patent application No. 60/504,226, which is incorporated herein by reference in its entirety.

### FIELD OF THE INVENTION

The present invention relates generally to the field of fluid separators, with common but by no means exclusive application to electrochemical cell systems.

### BACKGROUND OF THE INVENTION

Fuel cells and electrolyzer cells are generally referred to as electrochemical cells. Fuel cells have been proposed as clean, efficient and environmentally friendly power sources that have various applications. A conventional proton exchange membrane (PEM) fuel cell is typically comprised of an anode, a cathode, and a selective electrolytic membrane disposed between the two electrodes.

A fuel cell generates electricity by bringing a fuel gas (typically hydrogen) and an oxidant gas (typically oxygen) respectively to the anode and the cathode. In reaction, a fuel such as hydrogen is oxidized at the anode to form cations (protons) and electrons. The proton exchange membrane facilitates the migration of protons from the anode to the cathode while preventing the electrons from passing through the membrane. As a result, the electrons are forced to flow through an external circuit thus providing an electrical current. At the cathode, oxygen reacts with electrons returned from the electrical circuit to form anions. The anions formed at the cathode react with the protons that have crossed the membrane to form liquid water.

In contrast, an electrolyzer uses electricity to electrolyze water to generate oxygen from its anode and hydrogen from its cathode. Similar to a fuel cell, a typical solid polymer water electrolyzer (SPWE) or proton exchange membrane (PEM) electrolyzer is also comprised of an anode, a cathode and a proton exchange membrane disposed between the two electrodes. Water is introduced to, for example, the anode of the electrolyzer which in turn is connected to the positive pole of a suitable direct current voltage. Oxygen is produced at the anode. The protons then migrate from the anode to the cathode through the membrane. On the cathode which is connected to the negative pole of the direct current voltage, the protons conducted through the membrane are reduced to hydrogen.

In practice, the cells are not operated as single units. Rather, the cells are connected in series, either stacked one on top of the other or placed side by side. The series of cells, referred to as a cell stack, is normally enclosed in a housing. For a fuel cell stack, the fuel and oxidant are directed through manifolds in the housing to the electrodes. The fuel cell is cooled by either the reactants or a cooling medium. The fuel cell stack also comprises current collectors, cell-to-cell seals and insulation while the required piping and instrumentation are provided external to the fuel cell stack. The fuel cell stack, housing and associated hardware constitute a fuel cell module. Likewise, electrolyzer cells are also typically connected in series to form an electrolyzer stack.

A common problem that has to be addressed, for both fuel cell stacks and electrolyzer stacks, is the controlled removal of water from the process gas streams. The presence of water in the gas streams reduces the efficiency of the electrochemical cell.

The inventors have accordingly recognized a need for a fluid separation device for separating liquid from a fluid stream, and adapted for use with electrochemical cells.

### SUMMARY OF THE INVENTION

The invention is directed towards a liquid separator configured to separate liquid from a fluid stream.

The separator includes a housing, a separation chamber disposed within the housing and having a substantially cylindrical inner surface, wherein the inner surface of the separation chamber is aligned about a substantially vertical chamber axis, an inlet channel configured to communicate the fluid stream from a first inlet end to a second inlet end disposed within the housing and proximate an upper region of the separation chamber; and an outlet channel configured to communicate the fluid stream from a first outlet end positioned proximate the upper region of the separation chamber, to a second outlet end remote from the separation chamber. Proximate the second inlet end the inlet channel is aligned about an inlet axis and the inlet axis is proximate to and substantially parallel with a tangent to the inner surface of the separation chamber.

In another aspect, the invention is directed towards a liquid separator configured to separate liquid from a fluid stream. The separator includes a housing; a separation chamber disposed within the housing and having a substantially cylindrical inner surface, wherein the inner surface of the separation chamber is aligned about a substantially vertical chamber axis; an inlet channel configured to communicate the fluid stream from a first inlet end to a second inlet end disposed within the housing and proximate an upper region of the separation chamber; an outlet channel configured to communicate the fluid stream from a first outlet end positioned proximate the upper region of the separation chamber, to a second outlet end remote from the separation chamber; and a deflector vane. Proximate the second inlet end the inlet channel is aligned about an inlet axis; and the deflector vane is substantially aligned about the chamber axis and intersecting the inlet axis.

### BRIEF DESCRIPTION OF THE DRAWINGS

The present invention will now be described, by way of example only, with reference to the following drawings, in which like reference numerals refer to like parts and in which:

FIG. 1A is a side schematic view of a liquid separator made in accordance with the present invention;

FIG. 1B is a top schematic view of the liquid separator of FIG. 1;

FIG. 2A is a top perspective view of a first alternate embodiment of a liquid separator made in accordance with the present invention;

FIG. 2B is a side cutaway view of the liquid separator of FIG. 2A;

FIG. 3A is a side schematic view of a second alternate embodiment of a liquid separator made in accordance with the present invention;

FIG. 3B is a top schematic view of the liquid separator of FIG. 3B;

FIG. 4A is a top perspective view of a third alternative embodiment of a liquid separator made in accordance with the present invention;

FIG. 4B is a side cutaway view of the liquid separator of FIG. 4A;

FIG. 5 is a top perspective view of a deflector vane.

### DETAILED DESCRIPTION OF THE INVENTION

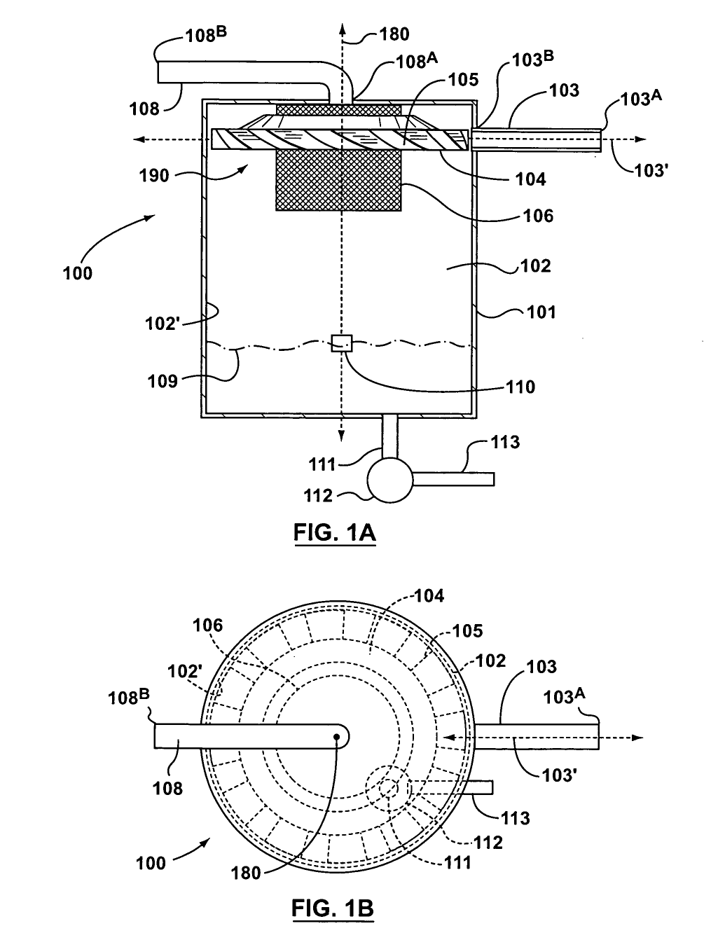

Referring simultaneously to FIGS. 1A and 1B, illustrated therein is a fluid separator, referred to generally as 100, made in accordance with the present invention. The assembly 100 includes a housing 101, having a separation chamber 102 disposed within an interior region of the housing. The inner surface 102′ of the separation chamber 102 is substantially cylindrical and is aligned about a generally vertical chamber axis 180.

A tubular inlet channel 103 is configured for communicating a fluid stream (typically comprising water droplets and oxygen or hydrogen as a process gas) from a first inlet end 103^{A} to a second inlet end 103^{B} proximate an upper region 190 of the separation chamber 102. Proximate the second inlet 103^{B}, the inlet channel 103 is aligned about an inlet axis 103′. Preferably the inlet axis 103′ is substantially horizontal.

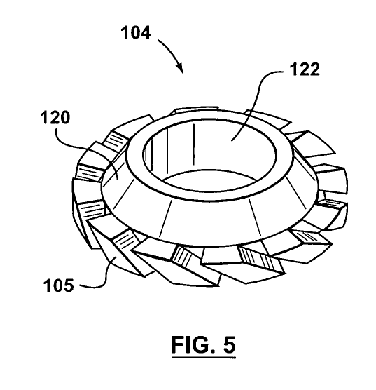

A deflector vane 104 (shown more clearly in FIG. 5), having a plurality of vanes 105, is positioned to intersect the inlet axis 103′. The deflector vane 104 is aligned about a deflector axis which is preferably substantially aligned with or collinear with the chamber axis 180. The deflector vane 104 is generally coplanar with a deflector plane (which in reference to FIG. 1B, would be parallel to the paper on which the Figure is printed), passing through each of the vanes 105 of the deflector 104.

Preferably the inlet axis 103′ is substantially coplanar with the deflector plane (or at least substantially parallel to the deflector plane). Preferably, too, the inlet axis 103′ is substantially orthogonal to the deflector vane axis 180. The deflector vane 104 is generally annular, and has an upper portion 120 which is generally frusto-conical in shape. The vanes 105 are arranged such that helically-inclined gaps are formed between adjacent vanes 105. A central bore 122 is also provided which extends axially through the deflector 104, and which may be threaded for mounting purposes.

A generally tubular outlet channel 108 is provided for communicating the fluid stream between a first outlet end 108^{A} proximate the upper region of the separation chamber 102 to a second outlet end 108^{B} remote from the separation chamber 102. The outlet channel 108 provides fluid communication between the separation chamber 102 and the exterior of the housing 101.

A generally cylindrical filter assembly 106 is provided proximate the first outlet end 108^{A}. The filter assembly 106 is disposed between the second inlet end 103^{B} and the first outlet end 108^{A} and configured to filter the fluid stream prior to entering the first outlet end 108^{A}. Typically, the filter assembly 106 may pass through or mount to the central bore of the deflector vane 104.

A drain 111 is provided proximate a lower region of the chamber 102. The drain 111 includes a drain passageway 113 for evacuating out of the separation chamber 102 liquid which has been separated from the fluid stream. A drain valve 112 is also preferably provided. A level switch 110 may be provided, which is operatively coupled to the drain valve 112. If the level of the upper surface 109 of the separated liquid exceeds a pre-determined maximum level, the level switch 110 causes the drain valve 112 to open, draining liquid from the chamber 102 until the upper surface 109 reaches a pre-determined minimum level.

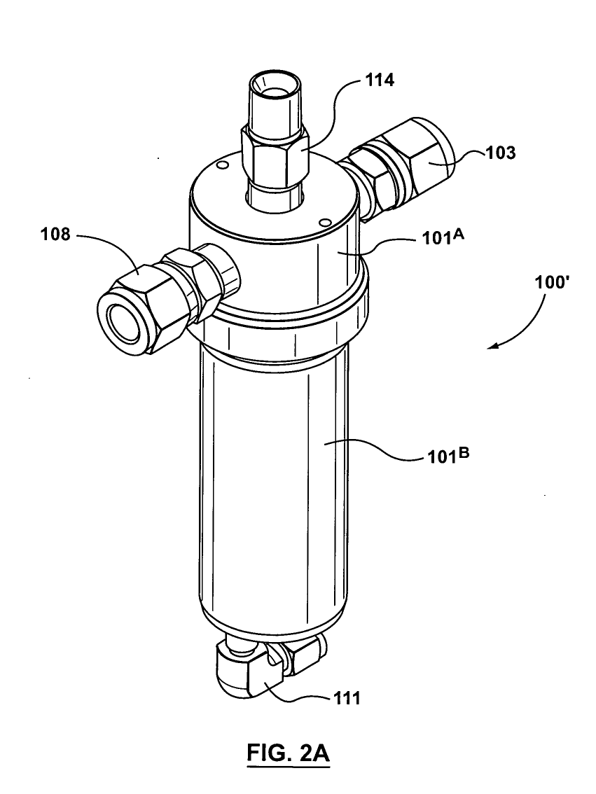

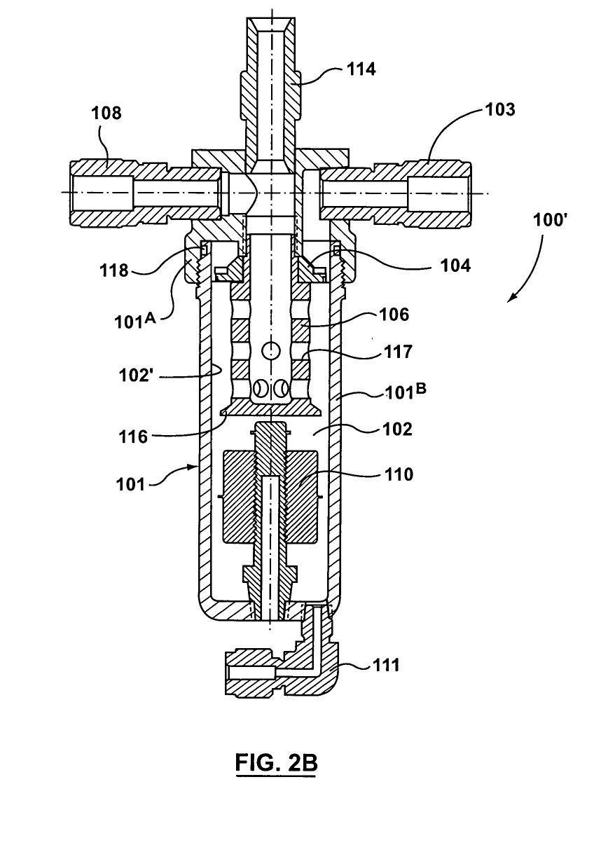

Referring now to FIGS. 2A and 2B, illustrated therein is a first alternate embodiment of the fluid separator 100′. Typically, the fluid separators 100, 100′ will receive a relatively high pressure fluid stream from the inlet channel 103. The first alternate separator 100′ comprises many of the same components as the separator 100 of FIGS. 1A and 1B. The separator 100′ is provided with a relief valve 114, to release gas in the event of overpressurization within the chamber 102. For certain electrolyzer applications, the relief valve will typically be set to vent gas somewhere in the range between 50 psi and 150 psi.

The housing 101 of the separator 100′ includes two removably attachable components: a cap portion 101^{A} and a base portion 101B. A seal 118 may be disposed between the cap portion 101^{A} and the base portion 101^{B}, to prevent fluid leaks.

The filter assembly 106 is preferably provided with a protruding lip 116 to deflect the fluid stream from the inlet channel 108 towards the inner surface 102′ of the separation chamber 102, further assisting in separating liquid from the fluid stream. Through holes 117 may be provided in the filter assembly 106. Different types of filters may be used in the filter assembly 106, including large pore ceramic, mesh screen or similar filtration mechanisms which facilitate separation of liquids and gases.

For both separators 100, 100′, in use, a fluid stream formed of a combination of gas and liquid droplets are directed under typically higher pressure into the first inlet end 103^{A} of the inlet channel 103. The fluid stream passes over the vanes 105 of the deflector 104, causing the fluid stream to swirl radially outwardly in cyclonic fashion and against the interior surface 102′ of the separation chamber 102. As will be understood, the spinning motion imparted to the fluid stream creates centrifugal forces which cause the liquid droplets to impinge upon and collect against the interior surface 102′ of the separation chamber 102. Gravity draws the liquid downwards to the chamber's 102 lowest points, and the liquid exits the chamber 102 through the drain 111.

The fluid stream (with at least some and preferably most of the liquid removed) is then able to pass through the filter assembly 106 and enter the outlet channel 108 via the first outlet end 108^{A}. The fluid stream then exits the separation chamber 102 and ultimately exits the outlet channel 108 and the separator 100,100′ through the second outlet end 108^{B}.

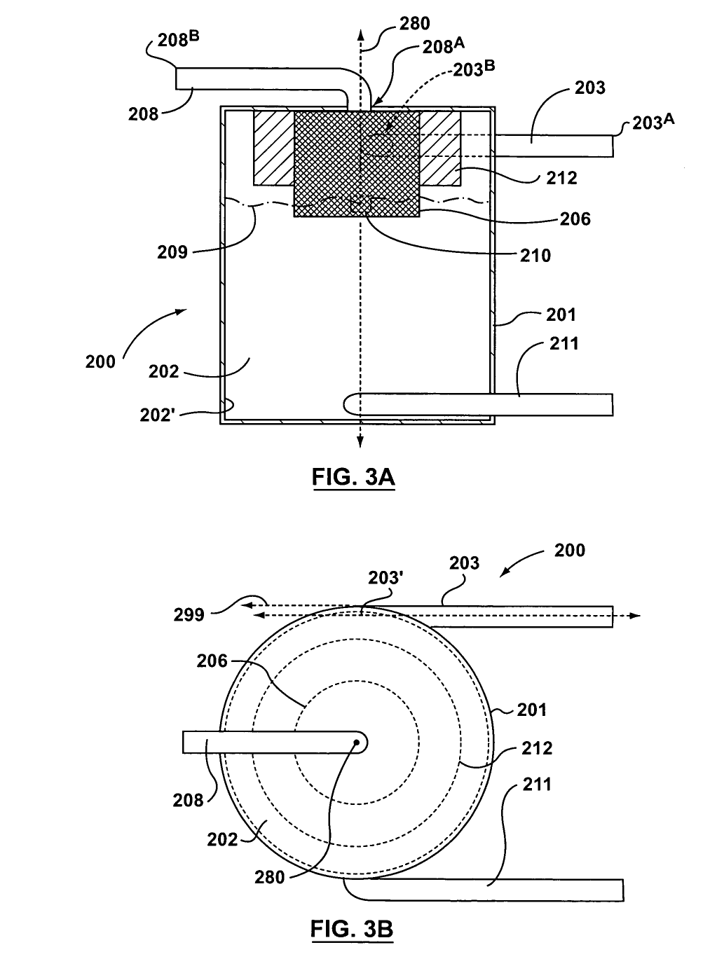

Referring now to FIGS. 3A and 3B, illustrated therein is a second alternate embodiment of a liquid separator, shown generally as 200. The separator assembly 200 includes a housing 201, having a separation chamber 202 disposed within an interior region of the housing 201. The inner surface 202′ of the separation chamber 202 is substantially cylindrical and is aligned about a generally vertical chamber axis 280. The diameter of the inner surface 202′ is selected to be sufficiently large such that fluid flow along the inner surface 202′ approximates laminar flow for improving liquid separation.

A tubular inlet channel 203 is configured for communicating a fluid stream (typically comprising water droplets and oxygen or hydrogen as a process gas) from a first inlet end 203^{A} to a second inlet end 203^{B} proximate an upper region 290 of the separation chamber 202. Proximate the second inlet 203^{B}, the inlet channel 203 is aligned about an inlet axis 203′. Preferably the inlet axis 203′ is substantially horizontal and is laterally displaced from the chamber axis 280. The inlet axis 203′ is proximate to and substantially parallel with a tangent 299 to the inner surface 202′ of the separation chamber 202. A deflector vane (not shown) similar to deflector 104 in FIG. 5, may be provided which is substantially aligned about the chamber axis 280 and which intersects the inlet axis 203′.

A generally tubular outlet channel 208 is provided for communicating the fluid stream between a first outlet end 208^{A} proximate the center of the upper region 290 of the separation chamber 202 to a second outlet end 208^{B} remote from the separation chamber 202. The outlet channel 208 provides fluid communication between the separation chamber 202 and the exterior of the housing 201.

A generally cylindrical screen or filter assembly 206 is provided proximate the first outlet end 208^{A}. The screen assembly 206 is disposed between the second inlet end 203^{B} and the first outlet end 208^{A} and configured to screen the fluid stream prior to entering the first outlet end 108^{A} and prevent separated liquid from splashing into the first outlet end 208^{A}.

A drain 211 is provided proximate a lower region 296 of the chamber 202. The drain 211 includes a drain passageway 213 for evacuating out of the separation chamber 202 liquid which has been separated from the fluid stream. A drain valve (not shown) is also preferably provided. A level switch 210 may also be provided, which is operatively coupled to the drain valve. If the level of the upper surface 209 of the separated liquid exceeds a pre-determined maximum level, the level switch 210 causes the drain valve to open, draining liquid from the chamber 202 until the upper surface 209 reaches a pre-determined minimum level.

Additionally, a volume displacement sleeve 212 will preferably be provided to reduce the volume of the upper region 290 of the separation chamber 202, and accordingly the amount of gas which may be stored there prior to evacuation through the outlet channel 208. Accordingly, if the process gas being separated from the fluid is oxygen, the decreased volume caused by the displacement sleeve 212 reduces the system start-up time (particularly for an electrolyzer system). The displacement sleeve 212 will typically be annular, and aligned about the chamber axis 280. The sleeve 212 will also preferably have an outer diameter which is smaller than the diameter of the inner surface 202′ of the separation chamber 202.

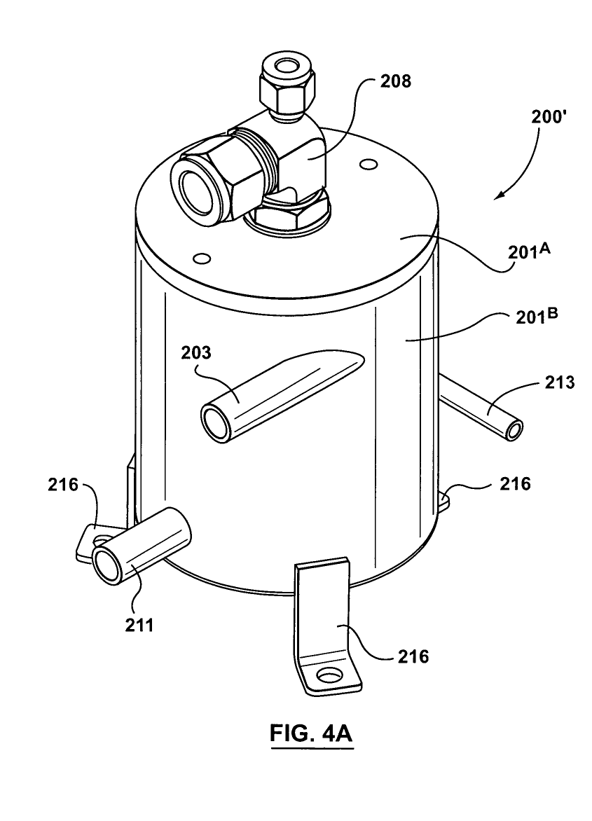

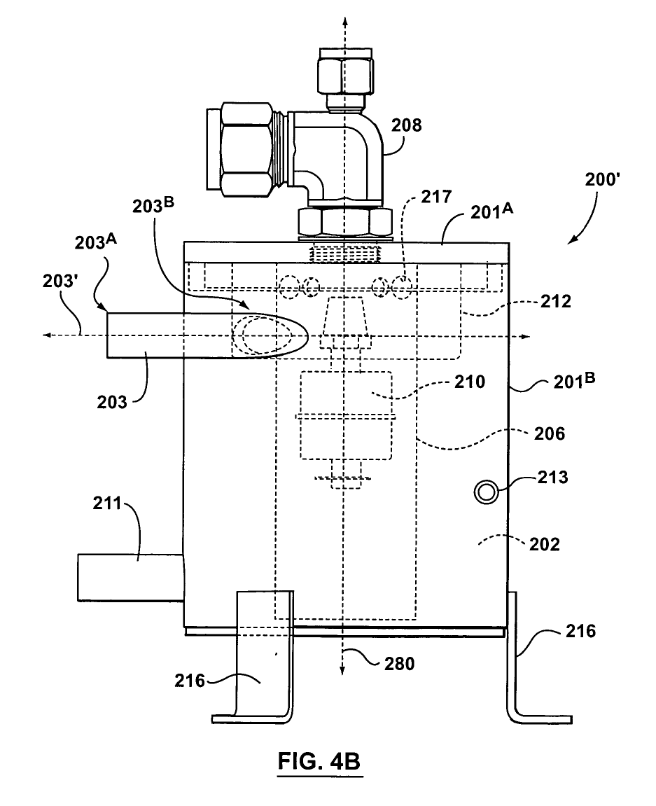

Referring now to FIGS. 4A and 4B, illustrated therein is a third alternate embodiment of the fluid separator 200′. Typically, the fluid separator 200′ will receive a lower pressure fluid stream from the inlet channel 203. The third alternate separator 200′ comprises many of the same components as the separator 200 of FIGS. 3A and 3B.

The separator 200′ is additionally provided with a liquid top-up inlet 213 to allow the introduction of extra liquid into the separation chamber 202 in the event the liquid stored in the chamber 202 is too low for efficient operation of the separator 200′. Alternatively extra liquid may be added by pumping extra liquid through the drain 211.

The housing 201 of the separator 200′ includes two removably attachable parts: a cap portion 201^{A} and a base portion 201^{B}. A seal 218 may be disposed between the cap portion 201^{A} and the base portion 201^{B}, to prevent fluid leaks. The cap 201^{A} may be removed from the base 201^{B}, to facilitate maintenance and cleaning of the separation chamber 202 and other components of the separator 200′. Mounting feet 216 may also be provided.

Preferably the screen assembly 206 reaches at least to the upper surface of the separated liquid in the separation chamber 202. Preferably, the separated liquid will be maintained at a desired displacement from the second inlet end 203^{B}. If the liquid level is too high, there is a risk that the liquid will exit through the outlet channel 208. Alternately, if the liquid level is too low, separated gas may exit out the drain 211, which is particularly undesirable if the process gas is oxygen for use in an electrolyzer system.

For both separators 200, 200′, in use, a fluid stream formed of a combination of gas and liquid droplets are directed under typically lower pressure into the first inlet end 203^{A} of the inlet channel 203. The fluid stream exits the second inlet end 203^{B} and travels along the inner surface 202′ of the separation chamber 202, in substantially laminar flow fashion. As will be understood, the laminar flow of the fluid stream along the inner surface 202′ effects separation of liquid droplets from the fluid stream and collect against the interior surface 202′. Gravity draws the liquid downwards to the chamber's 202 lowest points, and the liquid exits the chamber 202 through the drain 211.

The fluid stream (with at least some and preferably most of the liquid removed) is then able to pass through the screen assembly 206 and enter the outlet channel 208 via the first outlet end 208^{A}. The fluid stream then exits the separation chamber 202 and ultimately exits the outlet channel 208 and the separator 200,200′ through the second outlet end 208^{B}.

Thus, while what is shown and described herein constitute preferred embodiments of the subject invention, it should be understood that various changes can be made without departing from the subject invention, the scope of which is defined in the appended claims.

1. A liquid separator configured to separate liquid from a fluid stream, the separator comprising:
a) a housing;
b) a separation chamber disposed within the housing and having a substantially cylindrical inner surface, wherein the inner surface of the separation chamber is aligned about a substantially vertical chamber axis;
c) an inlet channel configured to communicate the fluid stream from a first inlet end to a second inlet end disposed within the housing and proximate an upper region of the separation chamber;
d) an outlet channel configured to communicate the fluid stream from a first outlet end positioned proximate the upper region of the separation chamber, to a second outlet end remote from the separation chamber;
e) wherein proximate the second inlet end the inlet channel is aligned about an inlet axis; and
f) wherein the inlet axis is proximate to and substantially parallel with a tangent to the inner surface of the separation chamber.

2. The liquid separator as claimed in claim 1, further comprising a deflector vane substantially aligned about the chamber axis and intersecting the inlet axis.

3. The liquid separator as claimed in claim 1, wherein the inner surface of the separation chamber comprises a diameter, and wherein the diameter is sized to be sufficiently large to facilitate laminar flow of the fluid stream on the inner surface upon exiting the second inlet end.

4. The liquid separator as claimed in claim 1, further comprising a filter assembly configured to filter the fluid stream prior to entering the first outlet end.

5. The liquid separator as claimed in claim 1, further comprising a drain having a drain passageway for draining liquid from the separation chamber.

6. The liquid separator as claimed in claim 5, wherein the drain further comprises a drain valve.

7. The liquid separator as claimed in claim 1, wherein the housing includes a base and a cap which is removably mountable to the base.

8. The liquid separator as claimed in claim 1, further comprising a volume displacer configured to reduce the volume of an upper region of the separation chamber.

9. A liquid separator configured to separate liquid from a fluid stream, the separator comprising:
a) a housing;
b) a separation chamber disposed within the housing and having a substantially cylindrical inner surface, wherein the inner surface of the separation chamber is aligned about a substantially vertical chamber axis;
c) an inlet channel configured to communicate the fluid stream from a first inlet end to a second inlet end disposed within the housing and proximate an upper region of the separation chamber;
d) an outlet channel configured to communicate the fluid stream from a first outlet end positioned proximate the upper region of the separation chamber, to a second outlet end remote from the separation chamber;
e) wherein proximate the second inlet end the inlet channel is aligned about an inlet axis;
f) a deflector vane aligned about a deflector vane axis, wherein the deflector vane axis is substantially aligned with the chamber axis; and
g) wherein the deflector vane intersects the inlet axis.

10. The liquid separator as claimed in claim 9, wherein the inlet axis is proximate to and substantially parallel with a tangent to the inner surface of the separation chamber.

11. The liquid separator as claimed in claim 9, wherein the inlet axis is substantially orthogonal to the deflector vane axis.

12. The liquid separator as claimed in claim 11, wherein the inlet axis is substantially horizontal.

13. The liquid separator as claimed in claim 9, wherein the deflector vane is substantially coplanar with a deflector plane.

14. The liquid separator as claimed in claim 13, wherein the inlet axis is substantially parallel to the deflector plane.

15. The liquid separator as claimed in claim 14, wherein the inlet axis is substantially coplanar with the deflector plane.

16. The liquid separator as claimed in claim 15, wherein the inlet axis is substantially orthogonal to the deflector vane axis.

17. The liquid separator as claimed in claim 9, further comprising a drain having a drain passageway for draining liquid from the separation chamber.

18. The liquid separator as claimed in claim 17, wherein the drain further comprises a drain valve.

19. The liquid separator as claimed in claim 9, wherein the housing includes a base and a cap which is removably mountable to the base.
